(19) United States
(12) Patent Application Publication
(10) Pub. No.: US 2007/0151036 A1
(43) Pub. Date: Jul. 5, 2007

(54) Method for Treating Textiles

(75) Inventors: Andreas Senf, Gasseldorf (DE); Toni Simenc, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Basf Aktiengesellschaft, Ludwigshafen (DE)

(21) Appl. No.: 10/586,410

(22) PCT Filed: Jan. 27, 2005
(86) PCT No.: PCT/EP05/00778

§ 371 Date: Jul. 18, 2006

(30) Foreign Application Priority Data
Jan. 29, 2004 (DE) 102004004722.7

(51) Int. Cl. C11D 3/00

(52) U.S. Cl. 8/115.51

(57) ABSTRACT

A textile treatment process comprises treating with (a) at least one alkali metal or ammonium salt of a copolymer, (b) at least one polysiloxane, (c) at least one solid material based on silicon dioxide, (d) and water.

The present invention relates to a process for treating a textile, which comprises treating said textile with
(a) at least one alkali metal or ammonium salt of a copolymer,
(b) at least one polysiloxane,
(c) at least one solid material based on silicon dioxide,
(d) and water.

The present invention further relates to a formulation useful for carrying out the process of the present invention and also to treated textile obtainable by the process of the present invention.

Textile materials, especially spun yarns, are treated with a solution, a dispersion or a melt of a macromolecular compound before they are processed. The macromolecular compound applied to the fiber can be washed off after processing. When such a treatment is carried out in order that higher smoothness, suppleness, strength and coherency may be achieved prior to weaving, this is referred to as sizing of yarns. Sizing agents, also known as sizes, are typically washed off again to a very substantial degree after weaving, in an operation also known as desizing.

Commonly used sizing agents are typically selected from natural macromolecular compounds such as for example starch, from modified natural macromolecular compounds such as for example modified starch and carboxymethylcellulose and from synthetic macromolecular compounds such as for example polyvinyl alcohol, polyesters and poly(meth)acrylates; see for example Ullmann's Encyclopedia of Industrial Chemistry, Vol. 36, 6th edition, pages 18-26, Wiley-VCH Weinheim, 2003. Numerous starch formulations, however, have poor running properties.

Treatment processes are therefore desired for sizes (but also for other applications to textiles) whereby the textile is treated with macromolecular compounds in order that the treated textile may have very good mechanical properties. In addition, the applied macromolecular compounds shall be readily removable with aqueous liquors.

Numerous prior art treating agents and especially sizing agents are observed to be prone to severe foaming when they are being applied. This results in an inhomogeneous application which, in the case of sizing agents, can have the effect that the desired improvement to the mechanical properties of the treated textile is not effected to a sufficient degree. Attempts to suppress the observed foaming through the addition of a defoamer, based on silicones for example, have not proved to be very successful. True, a decrease in foaming is observed in many cases, but oily spots form on the treated textile, and they may become deposited on rolls and lead to clumping. Nor are remnants of the oily spots observed fully removed, if at all, in the wash. Especially in the case of the combination of defoamers based on silicones with synthetic macromolecular compounds based on poly(meth)acrylates it is further observed that the mixtures are insufficiently stable in storage.

The present invention accordingly provides the process defined at the beginning.

Textile for the purposes of the present invention refers to linear structures such as textile fibers, including staple fibers, twine, filaments, rovings, spun yarns, lines, strings, cordage, threads. Textiles can be of natural origin, examples being silk, wool, flax, ramie, hemp or coir or especially cotton, or synthetic, examples being regenerated cellulose such as for example cuprammonium silk, viscose or cellulose acetates such as acetate and triacetate, also polyamide, polyacrylonitrile, polypropylene and polyester. Blends are also useful, examples being cotton-polyester blends. A textile for the purposes of the present invention may be present as staple fiber, in the form of filaments or as staple fiber yarn.

Textile treated by the process of the present invention can be of any color, and it can have one color or more than one color. Textile treated by the process of the present invention is preferably uncolored.

Textile in a preferred embodiment of the present invention refers to
warp yarns composed of cellulosic fiber, polyester-cellulosic blends, wool, polyester-wool blends, viscose filament or acetate filament or
warp yarns composed of flat or textured polyester filament.

In the present invention, textile is treated with
(a) at least one alkali metal or ammonium salt of a copolymer,
(b) at least one polysiloxane,
(c) at least one solid material based on silicon dioxide,
(d) and water.

In an embodiment of the present invention, the present invention's treatment is carried out in the presence of
(e) at least one protective colloid.

(a), (b), (c), (d) and (e) will hereinafter also be referred to as component (a), component (b), etc.

Alkali metal salts are salts of lithium, sodium, potassium, rubidium or cesium and especially of potassium and sodium. Ammonium salts are NH₄⁺ salts for example, but also (NR⁸R⁹R¹⁰R₁₁)⁺salts, wherein R⁸ to R¹¹ may be the same or different and are each selected from hydrogen, C₁-C₁₀-alkyl, C₆-C₁₄-aryl, C₃-C₁₂-cycloalkyl, benzyl or hydroxy -C₂-C₁₀-alkylene, especially —CH₂CH₂—OH, with the proviso that at least one of R⁸ to R¹¹ is other than hydrogen.

By alkali metal salts and ammonium salts of copolymers are meant those salts of copolymers wherein on average at least one and preferably at least two acidic groups per molecule of the corresponding copolymer are neutralized with alkali metal and ammonium respectively. In a specific embodiment of the present invention, (a) is a copolymer fully neutralized with alkali metal or ammonium.

Preferred alkali metal or ammonium salts of copolymers for use as component (a) according to the present invention are alkali metal or ammonium salts of carboxyl-containing copolymers, but it is also possible to use alkali metal or ammonium salts of copolymers comprising alcoholic hydroxyl groups for example or of sulfonates. Preference is given to such copolymers as are obtainable by copolymerization of (meth)acrylic acid with esters of unsaturated carboxylic acids.

(a) is more preferably an alkali metal or ammonium salt of at least one copolymer obtainable by copolymerization of
(a1) from 1% to 20% and preferably from 5% to 15% by weight of (meth)acrylic acid,
(a2) from 2% to 20% and preferably from 10% to 20% by weight of (meth)acrylonitrile and
(a3) from 30% to 80% and preferably from 40% to 60% by weight of at least one comonomer of the general formula I 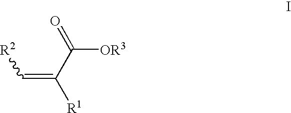
(a4) from 0% to 20% and preferably up to 10% by weight of at least one comonomer of the general formula II 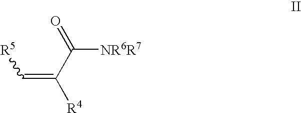
where
   R¹, R², R⁴ and R⁵ are the same or different and are each selected from
   hydrogen,
   C₁-C₁₀-alkyl, branched or unbranched, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; more preferably C₁-C₄-alkyl such as methyl, ethyl, n-propyl, isopropyl, n-butyl, isobutyl, sec-butyl and tert-butyl and most preferably methyl.
R⁶ and R⁷ are the same or different and are each selected from
   hydrogen,
   C₁-C₁₀-alkyl, branched or unbranched, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; more preferably C₁-C₄-alkyl such as methyl, ethyl, n-propyl, isopropyl, n-butyl, isobutyl, sec-butyl and tert-butyl,
   or R⁶ and R⁷ combine to form C₂-C₁₀-alkylene, substituted or unsubstituted, especially C₄-C₆-alkylene, especially —(CH₂)₄-, —(CH₂)₅- or —(CH₂)₆-.
R³ is selected from C₁-C₁₀-alkyl, branched or unbranched, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; more preferably C₁-C₄-alkyl such as methyl, ethyl, n-propyl, isopropyl, n-butyl, isobutyl, sec-butyl and tert-butyl.
Preferably, R² and R⁵ are both hydrogen.

In one embodiment of the present invention R¹ and R⁴ are each selected from hydrogen and methyl.

In a preferred embodiment of the present invention, R¹ and R⁴ are each selected from hydrogen and methyl and R² and R⁵ are both hydrogen.

In one embodiment of the present invention, at least two different comonomers (a3) are chosen.

In a preferred embodiment of the present invention, (a3) is selected from methyl acrylate, methyl methacrylate, ethyl acrylate, ethyl methacrylate, n-butyl acrylate, n-butyl methacrylate and mixtures thereof.

The values in % by weight are each based on the mass of the comonomer or comonomers in the copolymer used in the form of an alkali metal or ammonium salt as component (a) according to the present invention.

Copolymers which are used in the form of alkali metal or ammonium salts as component (a) according to the present invention can take the form of block copolymers, of alternating copolymers or preferably of random copolymers.

Copolymers which are used as component (a) according to the present invention or rather their alkali metal or ammonium salts are preparable by well-known methods, especially free-radical copolymerization, batchwise or continuously, for example bulk polymerization, emulsion polymerization, precipitation polymerization and solution polymerization, for example in water as a solvent.

In one embodiment of the present invention, at least one alkali metal or ammonium salt of a copolymer (a) has a dynamic viscosity in the range from 30 to 1500 mPa·s, preferably up to 800 and more preferably from 40 to 300 mPa·s, measured as a 25% by weight aqueous solution in accordance with DIN EN ISO 3219 at 23° C.

The present invention provides that at least one polysiloxane be used as component (b) in the process of the present invention. Polysiloxanes used according to the present invention can be linear, branched or cyclic polysiloxanes or mixtures thereof. Polysiloxanes used according to the invention have O—Si—O chains. The free valences on the silicon can be saturated for example by OH, C₁-C₁₀-alkyl or by phenyl, in which case phenyl and especially methyl are preferred. Polysiloxanes used as component (b) according to the present invention are well known.

In one embodiment of the present invention, at least one polysiloxane (b) has a dynamic viscosity in the range from 100 to 2000 mPa·s, preferably up to 500 and more preferably up to 200 mPa·s, measured in accordance with DIN EN ISO 3219 at 23° C.

The solid material based on silicon dioxide which is used as component (c) according to the present invention may be silica gel, for example. Silica gel used according to the present invention may comprise fractions of other elements, for example aluminum or sodium or calcium or mixtures thereof.

Sold material refers to material which is solid at room temperature.

Solid material based on silicon dioxide (c) is present in the present invention in the form of particles, which can be regular or preferably spherical in shape. The particles' number average diameter, determined for example by microscopic methods or by Coulter Counter, can be in the range from 0.1 nm to 1 μm.

One embodiment of the present invention utilizes such solid materials based on silicon dioxide (c) as have a number average diameter in the range from 0.1 nm to 100 μm and preferably in the range from 5 nm to 50 μm.

Solid materials based on silicon dioxide (c) are well known and can be produced by methods known to one skilled in the art, for example by precipitation by acidifying aqueous solutions of sodium metasilicate.

In one embodiment of the present invention, solid materials based on silicon dioxide have a BET internal surface area, as determined for example by nitrogen adsorption in accordance with DIN 66 131, in the range from 50 to 5000 m²/g, preferably in the range from 250 to 3000 m²/g and more preferably in the range from 350 to 1000 m²/g.

A preferred embodiment of the present invention utilizes such solid materials based on silicon dioxide (c) as are present in the form of agglomerates of so-called primary particles. Solid materials based on silicon dioxide (c) which are used in this form have a primary particle number average diameter in the range from 0.1 to 100 nm and preferably in the range from 5 to 50 nm. The number average diameter of agglomerates can be in the range from 60 nm to 100 μm, preferably in the range from 100 nm to 50 μm. Agglomerates of primary particles are generally substantially spherical in shape and can consist of from 4 primary particles up to more than one thousand primary particles.

One embodiment of the present invention utilizes at least one pyrogenic silica gel, also referred to herein as just pyrogenic silica, as solid material based on silicon dioxide (c). Pyrogenic silica gels are commercially available for example as Aerosil brands from Degussa. Particular preference is given to using pyrogenic silicas which are present in the form of agglomerates of primary particles and have an average surface area in the range from 50 to 5000 m²/g, preferably in the range from 250 to 3000 m²/g and more preferably in the range from 350 to 2000 m²/g.

The process of the present invention is carried out using water (d) which can be but need not be deionized (demineralized). The use of deionized water or of water having up to 2° German hardness is preferred. Deionized (demineralized or else completely ion-free) water is obtainable by methods known to one skilled in the art, examples being reverse osmosis or through use of ion exchangers.

A specific embodiment of the present invention has the treatment according to the present invention being carried out in the presence of at least one protective colloid (e). Surface-active compounds are useful as a protective colloid (e), and they can be anionic, cationic, zwitterionic or nonionic.

Particularly preferred protective colloids (e) are polymers of (meth)acrylic acid and copolymers of acrylic acid and methacrylic acid which can each be fully or partially neutralized by alkali metal or ammonium, the terms alkali metal and ammonium each being as defined above.

One embodiment of the present invention utilizes polymers or copolymers of (meth)acrylic acid which as a 28.5% by weight aqueous solution have a dynamic viscosity in the range from 2500 to 5000 mPa·s, as measured according to DIN EN ISO 3219.

Useful nonionic protective colloids (e) having preferential utility in the presence of at least one polymer or copolymer of (meth)acrylic acid include low-foam nonionic surfactants, preferably alkoxylated C₁₂-C₁₅ oxo process alcohols which have been alkoxylated with from 1 to 3 equivalents of alkylene oxide, preferably with ethylene oxide or propylene oxide.

The process of the present invention is preferably carried out using a ratio of about 2-15% by weight of liquor to textile. When the process of the present invention is practiced as a process for sizing textile, it is preferable to employ size add-ons in the range from 2% to 15%. Size add-on as used herein refers to the ratio of size to warp yarn.

One embodiment of the present invention utilizes the components in the following amounts:
from 1% to 30% by weight and preferably from 10% to 25% by weight of (a), based on the total amount of aqueous liquor or liquors,
from 0.001% to 5% by weight and preferably from 0.01% to 4% by weight of (b),
from 0.0001% to 5% by weight and preferably from 0.001% to 4% by weight of (c),
from 0% to 3% by weight and preferably from 0.0001% to 2% by weight of (e),
wherein the weight % of (b), (c) and (e) are each based on (a).

One embodiment of the process according to the present invention comprises treating a textile with an aqueous liquor comprising
(a) at least one alkali metal or ammonium salt of a copolymer,
(b) at least one polysiloxane,
(c) at least one solid material based on silicon dioxide, and if appropriate
(e) at least one protective colloid.

One embodiment of the present invention comprises practicing the process of the present invention at a temperature in the range from 10° C. to 35° C. and preferably in the range from 20 to 30° C.

One embodiment of the present invention comprises practicing the process of the present invention by pulling a textile, especially in the form of linear structures, over one or more rollers and through plural containers or preferably one container comprising one or more aqueous liquors comprising (a), (b), (c) and if appropriate (e). Excess aqueous moisture can subsequently be squeezed off. A textile which has been treated according to the present invention can subsequently be dried, for example by pulling it through a drying unit. Useful drying units include for example cylinder dryers. Drying is done for example at temperatures in the range from 90 to 130° C.

To treat a textile with plural aqueous liquors according to the present invention, one option is to allocate (a), (b), (c) and if appropriate (d) to different aqueous liquors.

A particularly preferred embodiment comprises treating a textile according to the present invention by adding (a), (b), (c) and if appropriate (e) to every or more preferably the aqueous liquor.

The treatment time of the textile with (a), (b), (c) and (d) and if appropriate (e) is typically short and depends on the speed with which the textile to be treated is pulled through the container or containers containing one or more liquors comprising (a), (b), (c), water and if appropriate (e). Typical machine speeds are in the range from 5 to 300 m/min. Machines pulling just a single yarn through one or more containers containing one or more liquors comprising (a), (b), (c), water and if appropriate (e) can be run at machine speeds of up to 500 m/min.

Aqueous liquors for carrying out the process of the present invention are preparable by mixing the desired components with water.

In addition to the above-described measures of the present invention, a textile may be additionally treated with waxes, for example polyolefin wax, for example polyethylene wax or polypropylene wax and also copolymer waxes of ethylene and propylene, oxidized polyethylenic wax and especially polyethylene oxide wax. Particular preference is given to treating with polyethylene oxide wax comprising on weight average from 20 to 250 ethylene oxide units per molecule.

In addition to the above-described measures of the present invention, a textile may further be treated with sulfonated tallow or sulfonated oil.

The present invention further provides an aqueous formulation comprising
(a) at least one alkali metal or ammonium salt of a copolymer,
(b) at least one polysiloxane,
(c) at least one solid material based on silicon dioxide,
   wherein said components (a), (b) and (c) are each as defined above.

The present invention further provides the aforementioned aqueous formulations which further comprise
(e) at least one protective colloid,
wherein component (e) is as defined above.

Aqueous formulations according to the present invention are particularly useful for practicing the process of the present invention which was defined at the outset.

In one embodiment of the present invention, (a) is an alkali metal or ammonium salt of a carboxyl-containing copolymer.

In one embodiment of the present invention (a) is an alkali metal or ammonium salt of at least one copolymer obtainable by copolymerization of
(a1) from 1% to 20% by weight of (meth)acrylic acid,
(a2) from 2% to 20% by weight of (meth)acrylonitrile,
(a3) from 30% to 80% by weight of at least one comonomer of the general formula I 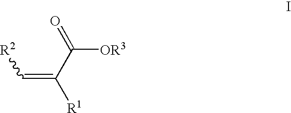
(a4) from 0% to 20% by weight of at least one amide of the general formula II 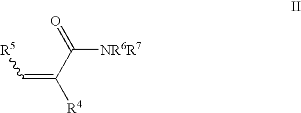
where
   R¹, R², R⁴ and R⁵ are each selected from hydrogen, branched C₁-C₁₀-alkyl and unbranched C₁-C₁₀-alkyl,
   R⁶ and R⁷ are each selected from hydrogen, branched C₁-C₁₀-alkyl and unbranched C₁-C₁₀-alkyl, or R⁶ and R⁷ combine to form C₂-C₁₀-alkylene,
   R³ is selected from branched C₁-C₁₀-alkyl and unbranched C₁-C₁₀-alkyl.

In one embodiment of the present invention at least one alkali metal or ammonium salt of a copolymer (a) has a dynamic viscosity in the range from 30 to 1500 mPa·s, preferably up to 800 and more preferably from 40 to 300 mPa·s, measured as a 25% by weight aqueous solution in accordance with DIN EN ISO 3219 at 23° C.

In one embodiment of the present invention at least one solid material based on silicon dioxide (c) is a pyrogenic silica gel.

In one embodiment of the present invention at least one polysiloxane (b) has a dynamic viscosity in the range from 100 to 2000 mPa·s, preferably up to 500 and more preferably up to 200 mPa·s, measured as a 25% by weight aqueous solution in accordance with DIN EN ISO 3219 at 23° C.

In one embodiment of the present invention, aqueous formulations according to the present invention comprise
from 2% to 80% by weight, preferably from 2.5% to 50% and more preferably up to 25% by weight of (a), based on the total weight of aqueous formulation according to the present invention,
from 0.001% to 5% by weight and preferably from 0.01% to 4% by weight of (b),
from 0.0001% to 5% by weight and preferably from 0.001% to 4% by weight of (c),
from 0% to 3% by weight and preferably from 0.0001% to 2% by weight of (e),
wherein the weight % of (b), (c) and (e) are each based on (a).

The above-described treatment process of the present invention may be carried out for example by aqueous formulation according to the present invention being diluted with further water and then used as an aqueous liquor.

Aqueous formulations according to the present invention are preparable for example by mixing components (a), (b) and (c) with water and if appropriate (e). The order of the addition of components (a) to (c) and if appropriate (e) is not critical.

Aqueous formulations according to the present invention are notable for good stability in storage.

The present invention further provides for the use of aqueous formulations according to the present invention for treating a textile. The present invention further provides a process for treating a textile by using aqueous formulations according to the present invention.

The present invention further provides a textile obtainable by the process of the present invention. The textile obtainable by the process of the present invention has excellent further-processing properties and comprises little by way of oily spots.

The present invention further provides a process for weaving textile fabrics and a process for spinning yam by using a textile according to the present invention, hereinafter both referred to as inventive textile-processing processes. The inventive textile-processing processes are particularly robust in operation.

Working examples illustrate the invention.

General Remarks:

Amounts given in g/l are each based on g/l of liquor.

Viscosity determinations were each carried out with a Brookfield spindle 2 at 100 revolutions/minute at 23° C on the lines of DIN EN ISO 3219.

1. Preparation of Aqueous Solutions of Alkali Metal Salts and Ammonium Salts of Copolymers

1.1. Preparation of an Aqueous Solution of Sodium Salt of Copolymer A1

Feed 1:

The following were mixed together in a stirred vessel:

2.88 metric tons of completely ion-free water

256 kg of a 15% by weight aqueous solution of sodium benzenesulfonate

183 kg of n-C₁₈H₃₇—(O—CH₂—CH₂)₁₈—OH

439 kg of freshly distilled methacrylic acid

1,83 metric tons of n-butyl acrylate

1.025 metric tons of methyl acrylate

14.6 kg of 25% by weight aqueous sodium hydroxide solution.

Feed 2:

The following were mixed together in a stirred vessel:

428 l of completely ion-free water and

11 kg of Na₂S₂0₈ (sodium peroxodisulfate).

Feed 3: 365 kg of freshly distilled acrylonitrile.

4.18 metric tons of completely ion-free water and 316 kg of 25% by weight aqueous sodium hydroxide solution were mixed together and heated to 65° C. in a further stirred vessel (feed 4).

A drum (drum 1) was used to mix together: 1951 of completely ion-free water, 14.3 kg of acetone and 23.6 kg of Na₂S₂0₅ (sodium disulfite). A further drum (drum 2) was used to mix together 1051 of completely ion-free water and 23 kg of tert-butyl hydroperoxide.

A 20 m³ stirred tank equipped with heater, condenser, stirrer and 3 feed openings was charged with 2.4 metric tons of completely ion-free water and 12.2 kg of a 15% by weight aqueous solution of sodium benzenesulfonate as an initial charge, and this initial charge was devolatilized and mixed together under nitrogen. The mixture thus obtained was subsequently heated to 80° C.

The hot mixture thus obtained was admixed with 166 kg of feed 1, 110 kg of feed 2 and 9 kg of feed 3. The polymerization kicked off. Thereafter, the remainders of feed 1, feed 2 and feed 3 were added concurrently over a period of 3 hours. On completion of the addition the mixture was stirred at 80° C. for one hour. Thereafter, feed 4 was added over a period of two hours and on completion of the addition the mixture was stirred at 80° C. for a further two hours.

The contents of drum 1 and drum 2 were subsequently added and the mixture was cooled to 34° C. by switching off the heating.

This provided an aqueous solution of copolymer Al as a sodium salt. Its solids content was 25%. Its dynamic viscosity, as determined according to DIN EN ISO 3219, was 100 ma·s.

1.2. Preparation of an Aqueous Solution of Mixed Sodium-ammonium Salt of Copolymer A2

The procedure described under 1.1 was followed, but feeds 1, 3 and 4 were prepared with modifications.

Feed 1 was prepared as follows: The following were mixed together in a stirred vessel:

2.88 metric tons of completely ion-free water

256 kg of a 15% by weight aqueous solution of sodium benzenesulfonate

183 kg of n-C₁₈H₃₇—(O—CH₂—CH₂)₁₈—OH

209 kg of freshly distilled methacrylic acid

644 kg of ethyl acrylate

2075 kg of methyl acrylate

14.6 kg of 25% by weight aqueous sodium hydroxide solution.

Feed 3: 622 kg of freshly distilled acrylonitrile.

Feed 4: 4.18 metric tons of completely ion-free water and 316 kg of 25% by weight aqueous ammonia solution were mixed together and heated to 65° C.

This provided an aqueous solution of copolymer A2 as a mixed sodium-ammonium salt. Its solids content was 25%. Its dynamic viscosity, as determined according to DIN EN ISO 3219, was 110 mPa·s.

1.3. Preparation of an Aqueous Solution of Sodium Salt of Copolymer A1

The procedure described under 1.2 was followed, except that feed 4 was prepared as follows:

4.18 metric tons of completely ion-free water and 316 kg of 25% by weight aqueous sodium hydroxide solution were mixed together and heated to 65° C.

This provided an aqueous solution of copolymer A3 as a sodium salt. Its solids content was 25%. Its dynamic viscosity, as determined according to DIN EN ISO 3219, was 80 mPa·s.

2. Preparation of Inventive Aqueous Formulations

Preliminaries:

The following were mixed together in a stirred tank:

32 kg of a polydimethylsiloxane having a dynamic viscosity of 100 mPa·s

3 kg of a pyrogenic silica gel, BET surface area 800 m²/g, as determined according to DIN 66 131, number average particle diameter 50 μm, as determined by Coulter Counter.

20 kg of a polyacrylic acid, partially neutralized, pH 7.0, dynamic viscosity of 28.5% by weight aqueous solution 3000 mPa·s at 28.5° C.

3 kg of n-C₁₁H₂₃—O(CH₂CH₂O)₃—H

80 l of completely ion-free water.

Premix 1 was obtained as a storage-stable emulsion.

2.1. Preparation of Inventive Aqueous Formulations F 2.1 to F 2.3

A stirred vessel was used to mix together premix 1 and aqueous solution of copolymer A1 as sodium salt or copolymer A2 as mixed sodium-ammonium salt or copolymer A3 as sodium salt as per table 1.

TABLE 1
Preparation of inventive formulations

| Number of | | | | |
|---|---|---|---|---|
| formulation | A1 [kg] | A2 [kg] | A3 [kg] | Premix 1 [g] |
| F 2.1 | 1 | — | — | 2 |
| F 2.2 | — | 1 | — | 2 |
| F 2.3 | — | — | 1 | 3 |

Inventive formulations F 2.1 to F2.3 were very stable in storage at room temperature and also at 50° C.; none of the inventive formulations tested showed discernible visual differences after a month of storage at room temperature or 50° C.

2.2. Determination of Foaming of Inventive Formulations and of Copolymers

Foaming was determined as follows on the lines of DIN 53 902.

Each test liquor (50 g/l of aqueous solution of copolymer or 50 g/l of inventive formulation) was heated to 80° C.

A 1500 ml capacity graduated cylinder, scale division 10 ml, was charged with 250 ml of the hot liquor (50 g/l of aqueous solution of copolymer or 50 g/l of inventive formulation) at 80° C. To generate foam, a beater piston equipped with a perforated disk (diameter: 60 mm, 24 centric drilled holes each 3 mm in diameter) was pushed up and down at a constant beating frequency to perform 20 beats within 20 seconds, the perforated disk being pulled out to the upper edge of the foam each time. On completion of foam generation the overall volume of liquid and foam was immediately measured and the volume of foam after predetermined standing times was determined as the difference between overall volume and liquid volume (i.e., without the foam).

The results are summarized in table 2.

TABLE 2
Foaming test

| | [ml of foam] | | |
|---|---|---|---|
| | immediately | | |
| Liquor | after completion | [ml of foam] | [ml of foam] |
| contains | of foam generation | after 1 minute | after 5 minutes |
| A1 | 650 | 480 | 250 |
| F 2.1 | 28 | 0 | 0 |
| F 2.1* | 28 | 0 | 0 |
| A2 | 600 | 450 | 280 |
| F 2.2 | 25 | 5 | 0 |
| F 2.2* | 28 | 8 | 0 |
| A3 | 750 | 510 | 310 |
| F 2.3 | 30 | 5 | 0 |
| F 2.3* | 29 | 5 | 0 |

Inventive formulations marked * relate to the particular inventive formulation after 30 days of storage at room temperature.

3. Treatment of a Textile

3.1. Preparation of an Aqueous Liquor for Treating a Textile and of a Comparative Liquor

64 kg of inventive aqueous formulation F 2.2 were prepared according to the recipe mentioned above and diluted with 136 l of completely ion-free water to obtain 2001 of inventive aqueous liquor FI-1. Dynamic viscosity: 300 ma·s.

A comparative liquor was prepared by stirring 64 kg of aqueous solution of copolymer A2 as a mixed sodium-ammonium salt together with 128 g of polydimethylsilicone defoamer and diluting with 136 l of completely ion-free water to obtain 200 l of aqueous comparative liquor FI-V2. Dynamic viscosity 30 ma·s.

3.2. Experimental Parameters of Textile Treatment

A singles 78 dtex 34 filament polyester warp yarn was treated on a BenSizeSingle sizing machine from Benninger equipped with a hot air cylinder dryer. The sizing machine settings were as follows:

Number of ends: 10 980, loomstate/reed width: 168 cm, ends/cm: 76.3

Concentration/refraction: 16° Brix

Liquor temperature: 25° C.

Treatment: 1× dipping, 1× squeezing off.

Average squeeze pressure: 18 kN

Wet separation: 3×, no dry separation

Machine speed: 300 m/min

Drying conditions: 2× air drying at 150° C., 5 rolls each at 145° C.

Afterwaxing: at 85° C. with polyethylene oxide wax which (weight average) comprises about 110 ethylene oxide units/molecule

Residual moisture content after drying: 0.4% by weight

Unwinding/input tension: 40 cN

Winding pressure: 18 cN/end, contact pressure: 200 N, no stretch

Liquor consumption 138 1/100 kg of polyester yarn, yarn weighting: 5% by weight

Each treated yarn was subsequently woven up as a warp yarn (10 warp beams at 12 000 m each)

3.3. Test Results of Inventive Textile Treatment and Comparative Test

A textile treatment was carried out under the conditions mentioned under 3.2, once with aqueous liquor FI-1 (inventive) and once with aqueous comparative liquor FI-V2.

The comparative test was found to give slight foaming after treatment of 1000 m of polyester warp yarn. There was a buildup of foam after treatment of 2000 m of polyester warp yarn. The foam remained even after addition of 0.3 g/l of polydimethylsilicone defoamer (see above). After treatment of 5000 m of polyester warp yarn, the rolls in the sizing machine were found to be severely contaminated, which made it necessary to switch off the machine and clean the rolls. After the rolls had been cleaned, the run was continued, but had to be discontinued again after treatment of 10 000 m of polyester warp yarn in order to clean the rolls again.

Inventive treatment of 1000 m of polyester warp yarn gave rise to minimal foaming, but no foam buildup occurred thereafter. There was no need to add a defoamer. The inventive treatment was continued without any problems. After inventive treatment of 10 000 m of polyester warp yarn, the treatment. The rolls were found to be uncontaminated.

The woven polyester fabric produced according to the present invention did not show any defects in the loomstate, and fabric appearance was impeccable. Loomstate fabric obtained by the comparative process had a stripy appearance.

1-12. (canceled)

13. A process for treating a textile, which comprises treating said textile with
(a) at least one alkali metal or ammonium salt of a copolymer obtainable by copolymerization of
(a1) from 1% to 20% by weight of (meth)acrylic acid,
(a2) from 2% to 20% by weight of (meth)acrylonitrile,
(a3) from 30% to 80% by weight of at least one comonomer of the general formula I 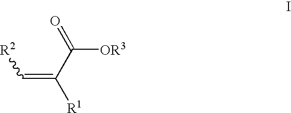
(a4) from 0% to 20% by weight of at least one amide of the general formula II 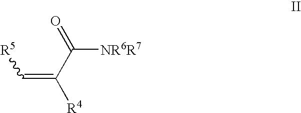
where
R¹, R², R⁴ and R⁵ are each selected from hydrogen, branched C₁-C₁₀-alkyl and unbranched C₁-C₁₀-alkyl,
R⁶ and R⁷ are each selected from hydrogen, branched C₁-C₁₀-alkyl and unbranched C₁-C₁₀-alkyl, or R₆ and R₇ combine to form C₂-C₁₀-alkylene,
R³ is selected from branched C₁-C₁₀-alkyl and unbranched C₁-C₁₀-alkyl.
(b) at least one polysiloxane,
(c) at least one solid material based on silicon dioxide,
(d) and water.

14. The process according to claim 13 wherein said treating is effected in the presence of
(e) at least one protective colloid.

15. The process according to claim 13 wherein at least one alkali metal or ammonium salt of a copolymer (a) has a dynamic viscosity in the range from 30 to 1500 mpa·s.

16. The process according to claim 13 wherein at least one solid material based on silicon dioxide (c) is a pyrogenic silica gel.

17. The process according to claim 15 wherein at least one polysiloxane (b) has a dynamic viscosity in the range from 100 to 2000 mPa·s.

18. An aqueous formulation comprising
(a) at least one alkali metal or ammonium salt of a copolymer obtainable by copolymerization of
(a1) from 1% to 20% by weight of (meth)acrylic acid,
(a2) from 2% to 20% by weight of (meth)acrylonitrile,
(a3) from 30% to 80% by weight of at least one comonomer of the general formula I 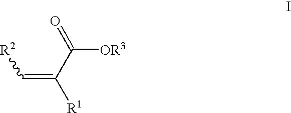
(a4) from 0% to 20% by weight of at least one amide of the general formula II 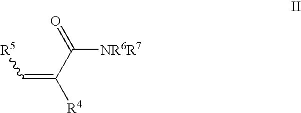
where
R¹, R², R⁴ and R⁵ are each selected from hydrogen, branched C₁-C₁₀-alkyl and unbranched C₁-C₁₀-alkyl,
R⁶ and R⁷ are each selected from hydrogen, branched C₁-C₁₀-alkyl and unbranched C₁-C₁₀-alkyl, or R⁶ and R⁷ combine to form C₂-C₁₀-alkylene,
R³ is selected from branched C₁-C₁₀-alkyl and unbranched C₁-C₁₀-alkyl,
(b) at least one alkali metal or ammonium salt of a copolymer,
(c) at least one polysiloxane,
(d) at least one solid material based on silicon dioxide.

19. The formulation according to claim 18 further comprising (e) at least one protective colloid.

20. The formulation according to claim 18 wherein wherein at least one alkali metal or ammonium salt of a copolymer (a) has a dynamic viscosity in the range from 40 to 800 mpa·s.

21. The formulation according to claim 18, wherein at least one solid material based on silicon dioxide (c) is a pyrogenic silica gel.

22. The formulation according to any of claim 18, wherein at least one polysiloxane (b) has a dynamic viscosity in the range from 100 to 200 ma·s.

23. A method of using the formulation according to claim 18 for treatment textile.

24. A process for treating a textile by using a formulation according to claim 18.
